(19) United States
(12) Patent Application Publication
(10) Pub. No.: US 2013/0282481 A1
(43) Pub. Date: Oct. 24, 2013

(54) SYSTEM AND METHODS FOR ELECTRONIC ADVERTISING MANAGEMENT

(71) Applicant: INCREASE VISIBILITY MEXICO, S. DE R.L. DE C.V., Mexico City (MX)

(72) Inventors: Gabriel Kent, Los Angles, CA (US); Pedro Quinzanos Cancino, Mexico City (MX); Daniel Molano Fajardo, Mexico City (MX)

(73) Assignee: Increase Visibility Mexico, S. de R.L. de C.V., Mexico City (MX)

(21) Appl. No.: 13/867,608

(22) Filed: Apr. 22, 2013

Related U.S. Application Data
(60) Provisional application No. 61/636,188, filed on Apr. 20, 2012.

(51) Int. Cl. G06Q 30/02

(52) U.S. Cl. CPC G06Q 30/0251
USPC 705/14.49

(57) ABSTRACT

An advertisement management method and system wherein a first set of phrases associated with a first party is received. A second set of phrases is determined, wherein each phrase in the second set is topically related to at least one phrase in the first set, and the second set includes at least one phrase from the first set. A third set of phrases is generated based on the second set. The second set includes at least one phrase that is not in the third set. The advertisement management method and system also receives social feed data, including first data posted on an online social network by a second party. A computer processor is used for automatically searching for matches between the first data and the third set of phrases. Responsive to a match identified by said searching, second data representing a social lead and including contact information of the second party is generated. In the advertisement management method and system, the first party is notified about the second data.

### CROSS-REFERENCE TO RELATED APPLICATION

This application claims priority under 35 U.S.C. §119(e) from co-pending Provisional Application Ser. No. 61/636,188, filed Apr. 20, 2012, the entirety of which is hereby incorporated by reference herein.

### BACKGROUND

The growth of the Internet has transformed many aspects of commerce, bringing merchants and consumers together in numerous new ways. As online commercial interactions proliferate, it has become increasingly important for a merchant to keep track of its customer base and find new ways to pursue business leads. The Internet offers opportunities to reach out to customers and distribute advertising and marketing messages at low cost, e.g., on a merchant's website or through targeted search advertisements. Whereas consumers formerly relied on cumbersome materials such as phone books to identify and locate service providers, similar functionality is now provided online, including transformative capabilities such as search engines. Another trend that has changed the marketing landscape recently is the integration of social networking into many areas of people's lives. Consumers who formerly received advertisements via television or radio are now spending more time online, interacting with others in online communities.

### SUMMARY

In certain embodiments of an advertisement management method and system disclosed herein, a first set of one or more phrases associated with a first party, e.g. a particular merchant, is received from the first party. Using at least one computer processor, a second set of one or more phrases is determined based on the first set, wherein each phrase in the second set is topically related to at least one phrase in the first set, and the second set includes at least one phrase from the first set of phrases. Using at least one computer processor, a third set of phrases is generated based on the second set of phrases, the second set including at least one phrase that is not in the third set. Social feed data, including first data posted on at least one online social network by a second party, is received. The system and method utilizes a computer to search for matches between the first data and the third set of phrases. Responsive to an identified match identified by said searching, second data representing a social lead is generated. The second data includes contact information of the second party. The first party is notified about the second data.

In certain embodiments, the advertisement management method and system includes a non-transitory computer-readable storage medium comprising computer-executable instructions stored thereon. When executed, the instructions cause at least one computer processor to perform the operations described above.

In certain embodiments of an advertisement management method and system described herein, a first set of one or more phrases associated with a first party is received from the first party. Using at least one computer processor, a second set of one or more phrases is determined based on the first set. Each phrase in the second set is topically related to at least one phrase in the first set and is associated with a relevance score and a popularity score. The second set of phrases includes at least one phrase from the first set of phrases. The second set of phrases is sorted by at least one of the associated relevance scores and the associated popularity scores. Based on said sorting, a strict subset of the second set of phrases is determined. Social feed data, including first data posted on at least one online social network by a second party, is received. At least one computer processor is used for automatically searching for matches (e.g., textual match) between the first data and the phrases in the strict subset of the second set of phrases. Responsive to an identified match identified by said searching, a message is extracted which includes the first data from the social feed data, the message is compared against a set of one or more intent phrase fragments, and a numerical score is associated with the identified match. The numerical score depends on whether the message includes at least one of the intent phrase fragments. Responsive to a comparison between the numerical score and a predetermined threshold, second data representing a social lead is generated. The second data includes contact information of the second party.

### BRIEF DESCRIPTION OF THE DRAWINGS

The following will be apparent from elements of the figures, which are provided for illustrative purposes and are not necessarily to scale.

FIG. 1 is a block diagram showing an advertising management system in accordance with certain embodiments of the present disclosure that assists merchants in providing advertisements to consumers via a network such as the Internet.

FIG. 2 is a system architecture diagram showing an example implementation of an advertising management system in accordance with certain embodiments of the present disclosure.

FIG. 3 is a flow diagram of a process in accordance with certain embodiments of the present disclosure for generating and tracking leads based on content posted to social broadcast sites.

FIG. 4 is a flow diagram for phrase processing in accordance with certain embodiments of the present disclosure.

FIG. 5 is a flow diagram of a process for secondary direct marketing based on group coupons in accordance with certain embodiments of the present disclosure.

FIGS. 6A-6I are example depictions of dashboards for presenting information via an advertising management system in accordance with certain embodiments of the present disclosure.

FIG. 7 is a flow diagram of a process in accordance with certain embodiments of the present disclosure.

FIG. 8 is a flow diagram of a process in accordance with certain embodiment of the present disclosure s.

### DETAILED DESCRIPTION

This description of the exemplary embodiments is intended to be read in connection with the accompanying drawings, which are to be considered part of the entire written description.

In various embodiments of the present disclosure, a computer based advertising platform provides efficient coordination, management, delivery, and/or tracking of advertising campaigns for various entities (e.g., merchants) that advertise their products (e.g., goods and/or services) to customers (e.g., consumers in a marketplace). The advertising platform may also function as a self-serve portal for merchants to login to and access various functionality related to advertising campaigns, including targeted and direct (e.g., person-specific) advertising campaigns. The advertising management platform integrates various marketing products that have previously only been available separately using conventional technologies. Using such integrated services in one single sign-on (SSO) suite, various embodiments provide unified reporting for all marketing channels, tailored to specific levels for respective merchants, to enable merchants to deploy products rapidly to customers, e.g., via the Internet.

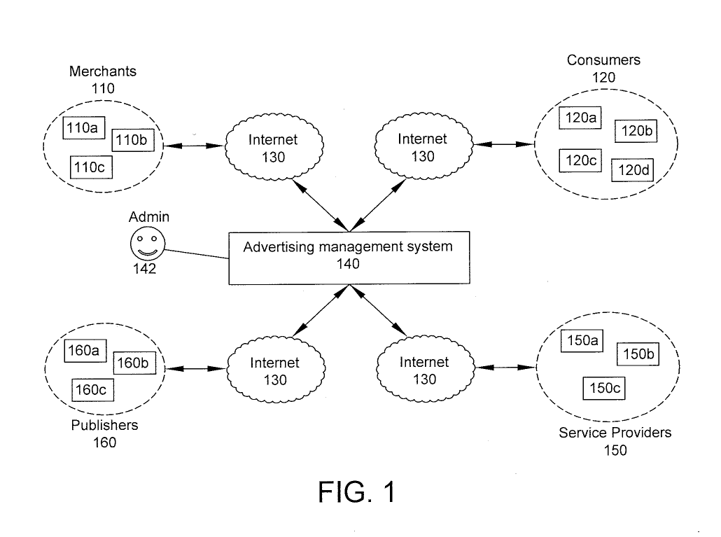

FIG. 1 is a block diagram showing an advertising management system 140 that assists merchants 110 in providing advertisements, including targeted advertisements and other forms of marketing, to consumers 120, e.g., via a network 130 such as the Internet. Merchants may be individuals or entities that provide any type of product or service. Although particular merchants 110a, 110b, 110c and consumers 120a, 120b, 120c, 120d are shown as examples, any number of merchants and consumers may be served with system 140. A consumer may be an existing customer of a merchant's products or may be a potential new customer. In addition to showing the merchants 110 who use system 140, FIG. 1 shows an administrator 142 who operates system 140 (performs system administration tasks relating to the system). System 140 is referred to herein as an advertising management system, but can be used for various types of direct or online advertising and marketing, including targeted advertising. Although one administrator is shown as an example, there may be several administrators. FIG. 1 also shows publishers 160a, 160b, 160c (collectively “publishers 160”) who may interface with network 130 to publish advertising materials of merchants 110 on the network, e.g., in the form of merchant web sites. Various entities in FIG. 1 (e.g., merchants 110) may also connect to advertising service providers 150a, 150b, 150c (collectively “advertising service providers 150”), such as ad networks (e.g., Google AdSense).

Previously, merchants desiring to create an Internet presence for marketing, advertising and/or delivering targeted offers to consumers have had to face numerous challenges. One challenge is that various services associated with maintaining an Internet presence have only been available from distinct sources. A merchant seeking to initiate and maintain an operational web presence has previously had to identify and engage numerous distinct service providers (e.g., advertising service providers 150) individually, resulting in a cumbersome an inefficient experience. Additionally, once a web presence is established, tools for delivering website visitors with various types of features online have previously not been streamlined. Yet another challenge is that without an integrated advertising solution, marketing capabilities have been limited because different functional units of a merchant's virtual storefront have not been able to communicate effectively with one another. In various embodiments of the present disclosure, advertising management system 140 efficiently aggregates and/or integrates various services provided by service providers 150, so that merchants 110 may have a single sign-on portal for maintaining a web presence and a web-based advertising and marketing campaign.

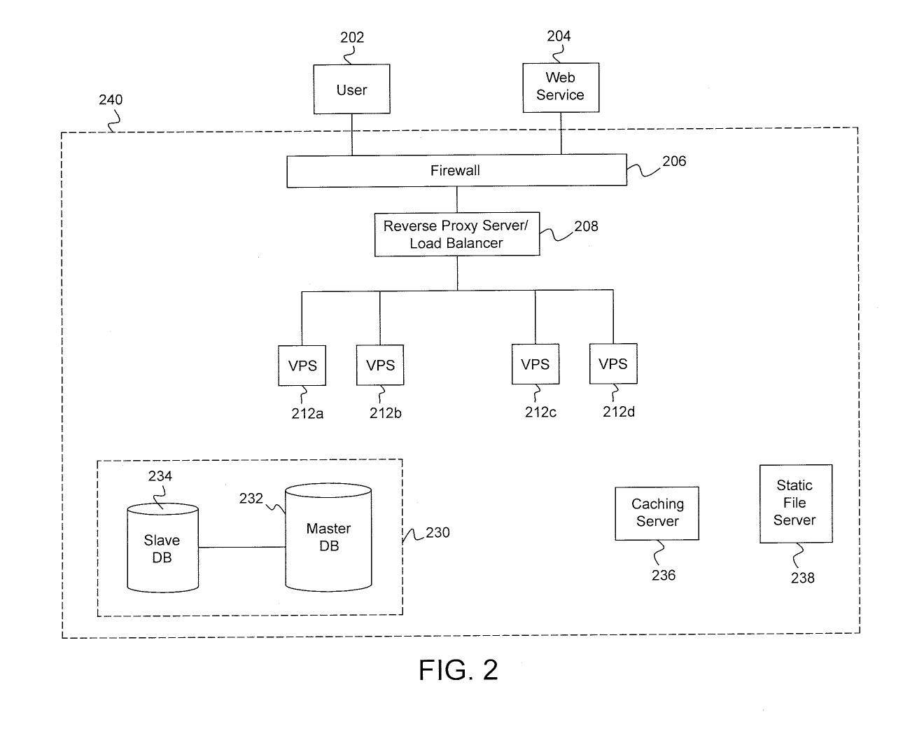

FIG. 2 is a system architecture diagram showing a system 240 that may correspond to an example implementation of advertising management system 140. System 240 may provide an interface for receiving inputs from a user 202 or a web service 204. User 202 may be a person who interacts with system 240, e.g., an administrator, customer services individual, merchant 110, or another web visitor such as a publisher 160 or an employee associated with a publisher. A web service component 204 may be processed into system 204 to provide automated interaction. In certain embodiments, the processing within system is the same regardless of whether input(s) are received from a human user or an automated web service.

A firewall 206 may be provided near an entry point of system 240 to provide security, e.g., to protect against web-based attacks. A reverse proxy server/load balancer module 208 may retrieve resources on behalf of a client (e.g., user 202 or web service 204) from one or more virtual private servers (VPS's) 212a, 212b, 212c, 212d (collectively, “VPS's 212”) and may allocate requests between various VPS's based on dynamic considerations, as is known in the art of cloud computing. Each VPS 212 is a virtual machine that is functionally equivalent to a physical computer configured to run server software. A database module 230 may provide storage of data related to system 240, e.g., data related to a particular merchant's advertising campaign. A master/slave configuration may be used, with a master database 232 acting as a live-time or real-time database that stores changes as they occur. The master database 232 may synchronize a slave database 234, which is accessed to reduce resource requirements of the master database 232 so that the master database 232 can focus on real-time operation. A caching server 236 may cache (e.g., in random access memory) results of commonly used operations within system 240 (e.g., particular operations or interactions from user 202 or web service 204) to improve speed. A static file server 238 may provide functionality of a content delivery network to provide static elements, e.g., web content such as images or cascading style sheets (CSS) to be served to a client such as user 202 or web service 204. The caching server 236 and static file server 238 may be configured according to standard virtualization configurations, and the components shown within system 240 in FIG. 2 may be virtualized in a cloud network through a cloud service provider as known to one of ordinary skill in cloud computing.

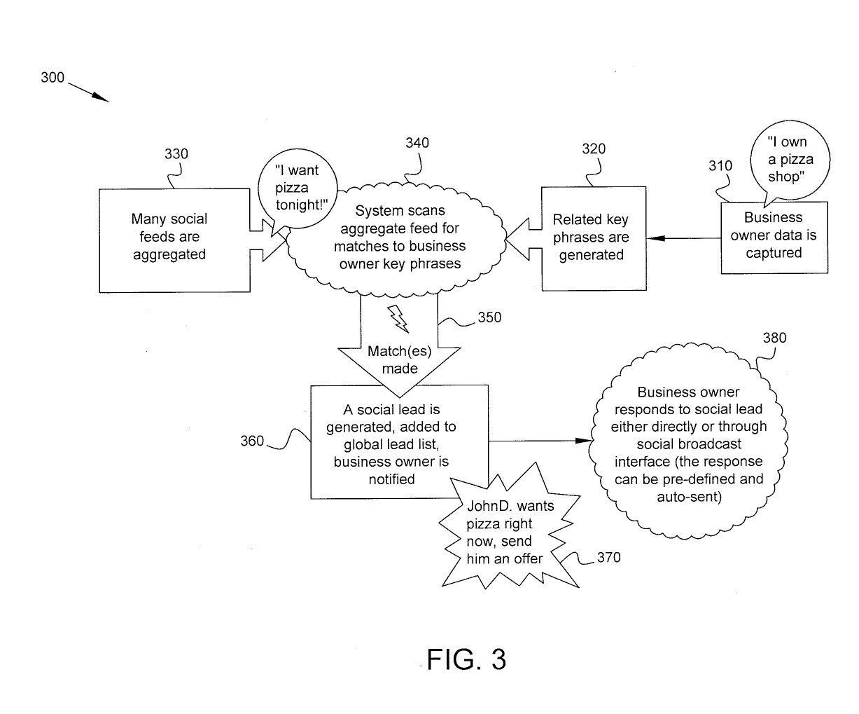

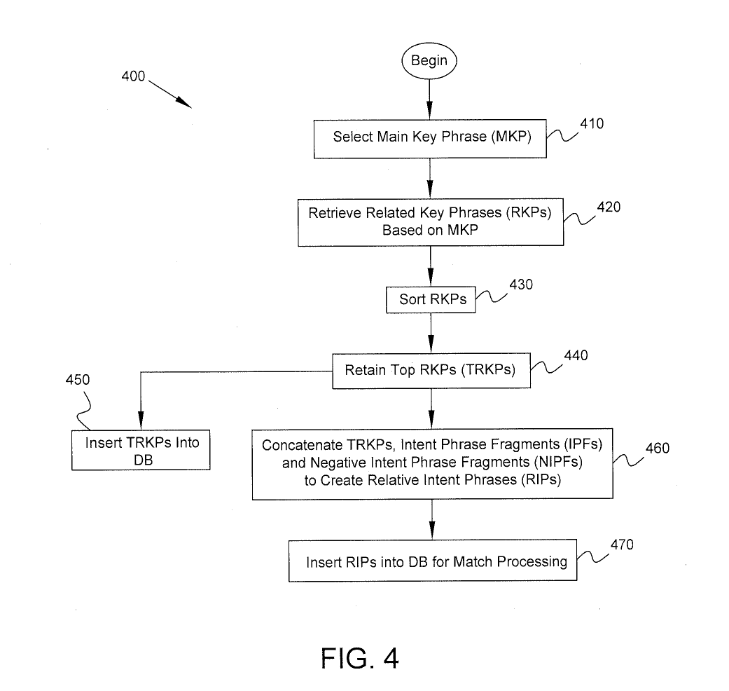

Some embodiments of the present disclosure provide generation and tracking of leads from social broadcasting sources. FIG. 3 is an example flow diagram for process 300 which corresponds to high-level social leads generation and tracking. Certain aspects of the lower-level details for implementing process 300 are described further below in the context of FIG. 4. Referring to FIG. 3, at block 310, a merchant, e.g., an owner of a pizza shop, provides information about the products and services offered, e.g., a phrase including one or more words such as “pizza” that describes the business or a longer phrase such as “I own a pizza shop” as shown in FIG. 3. At block 320, related key phrases (e.g., “pizza pie,” “deep dish,” “new york style,” or “italian food”) are generated automatically in certain embodiments. In other embodiments, related key phrases are not generated. A merchant can input various attributes of its business into the system, including information regarding numerous products and services; the location of the business, the cost, etc. All or just some of this information can be analyzed for the purpose of generating leads. The example above concerning “pizza” is a simple example.

Individuals post various types of information to social networking websites and social networking applications. As used herein, the term “online social network” encompasses social networking websites, and related technologies such as online social discussion websites, social bookmarking websites, and online community forums, as well as similar technologies that are accessed by non-website mechanisms (e.g., applications running on a computing device such as a smartphone). Online social networks in the context of the present disclosure enable users to post information accessible by other users and can but do not have to provide the capability for direct “friendship”-like links between users. Various online social networks provide the ability for users to post short text messages which will be shared with other users according to various rules (e.g., based on subscription-like paradigms, friendship status, degrees of separation, etc.). Some of the posted information may reveal that an individual is a potential consumer for the pizza merchant's products (to use the foregoing pizza merchant as just one example). Previously, such a pizza merchant had no way to efficiently access this valuable information and no way to use that information effectively to gather new business leads.

In certain embodiments of the present disclosure, social broadcast feeds are aggregated at block 330. The aggregated broadcast feed may be obtained from a social feed aggregator that aggregates the feeds and provides a scripting environment to filter and process the aggregated data. An aggregate social feed may include content from a single person or from many people and may include contact information for the user(s) (e.g., based on a user ID or an email address) and/or information about the identity of such user(s) (e.g., name of the user).

At block 340, system 140 scans the aggregate feed for matches to the key phrases associated with the pizza merchant that were determined in the manner described above. A match is indicative of a business lead for the merchant. When a match occurs (350), a lead is generated (such a lead is referred to as a “social lead” because it arises based on a social broadcast feed) and added to a global lead list for the merchant, and the merchant is notified (block 360), e.g., via a dashboard of system 140 that the merchant can logon to or via a direct message through another channel (such as email, text message, or a popup window in a smartphone application). A merchant may receive notification from system 140 of a new social lead using any suitable notification mechanism, e.g., email, instant message, text message, beeper message, an alert on an electronic application running on a smartphone, or any other electronic messaging interface.

As a result of the social lead, an inference 370 is drawn, namely, that a potential customer might want a product of the merchant (e.g., pizza) currently, and that that a present limited time period would provide an opportune time to target the potential customer with a tailored offer. At 380, the merchant can then respond to the lead either directly (e.g., by emailing the consumer) or through system 140. A response (e.g., message which may include promotional materials and/or a coupon) may be pre-defined and automatically sent by system 140.

The merchant may log into system 140 to view a dashboard displaying information about the lead, and may send a message to person corresponding to the social lead via system 140. Templated offers may be preconfigured, and optionally dynamically adjusted, for this purpose. Thus, somebody (e.g., John Doe) who posts a status update “I want pizza tonight!” on a social networking site can be identified in real-time as a potential business opportunity for a pizza merchant, and the merchant can send John Doe a pizza offer (or other promotional materials related to pizza or the merchant's business) responsively, also in real-time (or nearly real-time, taking into consideration the usual delays associated with electronic message delivery). Hence, direct advertising is efficiently and precisely conducted at a personalized level, to the individual(s) who may be most receptive to such advertising. Such real-time lead notification has not been available with conventional advertising systems and opens up new possibilities for e-commerce. A promotional message can be sent electronically to John Doe regarding any topic associated with the identified match described above, and the message can be sent automatically based on a previously configured rule, or in response to an instruction received from the merchant. For example, a merchant who logs in to a portal to view a list of social leads may decide that only some of the leads are promising enough to warrant sending out targeted promotional materials that include a discount.

FIG. 4 is a flow diagram for phrase processing in accordance with certain embodiments. At block 410, a main key phrase (referred to herein as “MKP”) is selected. This MKP may have been entered by a merchant, e.g., at block 310 of FIG. 3, and may be the word “pizza,” for example. As previously explained, the MKP may be any phrase associated with the products or services of the merchant, including the types of products, services, price range, and/or location descriptor such as “New York City.” At block 420, one or more other phrases, which may be topically related and/or semantically related to the original MKP, are optionally generated, e.g., by a software call to an appropriate API, and these generated phrases may be optionally pooled together with the MKP, with the aggregate being referred to as related key phrases (RKPs). Using the example of block 320 of FIG. 3, phrases such as “pizza pie,” “deep dish,” “new york style pizza,” or “italian food” may be semantically related to MKP “pizza.”

In certain embodiments, a relevance score and/or a popularity score may be associated with each RKP. The relevance score may be indicative of how related the corresponding RKP is in comparison to the original MKP (e.g., semantic or topical relevance). The popularity score may reflect popularity according to various measures, e.g., it may be indicative of how often the corresponding RKP was previously searched for on one or more search engines, or it may be based on polls or surveys of popular/trending topics. For example, if the MKP “lions for sale” is used, then the relevance score will be higher for RKPs pertaining to actual lions (the large, feline mammal) than the relevance score for RKPs pertaining to the Detroit Lions (although the latter may have higher popularity scores due to the popularity of the football team). Regardless of how the relevance scores and popularity scores are actually implemented (e.g., as a numerical score in a particular range), the RKPs may be sorted (block 430) according to their relevance and/or popularity scores. For example, in one embodiment, the RKPs are sorted first by their relevance scores, and for any RKPs that have equal relevance scores, tiebreaking is achieved by performing a second sort according to popularity scores.

At block 440, pruning may be performed based on the sorting. For example, a predetermined proportion P of the RKPs that are ranked lowest according to the sorting may be excluded (or equivalently, a predetermined proportion of the RKPs that are ranked highest may be retained). The resulting top phrases, which are retained, are referred to as top RKPs (TRKPs). These retained phrases may be a strict (proper) subset of the overall RKPs. For example, the top 60% (after sorting) of the RKPs may be retained as TRKPs, with the other 40% being excluded. In other embodiments, instead of retaining a fixed percentage of phrases that are at the front of the sorted list of RKPs, retention may be based on an absolute number of phrases to be kept, or may be based on a score threshold (for relevance score and/or popularity score).

In whatever way the TRKPs are determined, the TRKPs are inserted (block 450) into a database (e.g., database 232 or 234, or a different database) for match processing. The TRKPs are also used for additional processing shown at block 460. At block 460, intent phrase fragments (referred to herein as “IPFs”, and sometimes referred to as positive intent phrase fragments) and negative intent phrase fragments (referred to herein as “NIPFs”) are retrieved from a database, and they are concatenated with the TRKPs to create relative intent phrases (referred to herein as “RIPs”). For example, an IPF “I love” (or “I want”) may be prepended to a TRKP “italian food” to yield a RIP “I love italian food” or a NIPF “I hate” may be prepended to a TRKP “new york style pizza” to yield a RIP “I hate new york style pizza.” The TRKPs may be referred to as “naked” phrases because they have not yet been joined to IPFs or NIPFs, and the relative intent phrases may also be referred to as “rendered” intent phrases because intent phrases (whether positive or negative intent) have been rendered into such phrases.

At block 470, the RIPs are inserted into a database for subsequent match processing. Because the TRKPs are saved in the database at block 450, they can be used to regenerate RIPs if needed. The insertion of TRKPs and RIPs into a database at blocks 450 and 470, respectively may correspond to database commands that are used for adding records.

In certain embodiments of the present disclosure, string comparison processing is used to match RIPs against social feed input (e.g., from an aggregated social feed, containing data posted by one or more users). Various techniques may be used to perform such string matching. For example, in one implementation, the social feed input and the naked phrases are in a database, and a database instruction (such as the “LIKE” condition in the SQL or mySQL database language) is used to automatically determine whether any of the RIPs match any portion of the social feed input. Various database techniques for querying a dataset for keywords that are “like” pizza (for example) may be used. Various other string matching techniques may be used in other implementations. String matching in accordance with various embodiments does not necessarily have to find exact string matches; in certain implementations, stemming is supported, so that variations such as different verb tenses, singular versus plural, etc. are accounted for. Punctuation marks may be stripped to facilitate string matching. In certain implementations, embedded words within a phrase will still yield a match, e.g., “pizza pie” may match “pizza pepperoni pie.” Optionally, queries may be limited by location (e.g., so that only matches in the same city as the merchant will be returned).

If a match is detected for a particular RIP, then a quality rating is assigned to (associated to) the match depending on the nature of the RIP. For example, if the matching RIP was formed as the concatenation of a naked phrase with an IPF, then a quality rating of a first type is assigned, whereas if the matching RIP was formed as the concatenation of a naked phrase with a NIPF, then a quality rating of a second type is assigned. The first and second types may be numerical scores of a first sign (e.g., positive) and a second sign (e.g., negative), respectively, although various other rating methodologies can be used as well. In an example implementation in which positive and negative scores are used for the first and second types, the magnitude of the score may be determined according to the popularity of the corresponding RIP or the popularity of the corresponding RKP that formed that RIP. For example, a matching RIP that contains a highly popular RKP may be assigned a relatively high positive score. In certain embodiments, the scores are normalized, e.g., with all scores lying in the range [−1, 1] (i.e., greater than or equal to −1, and less than or equal to 1). In such an example, a matching RIP that contains a highly popular RKP may be assigned a score such as 0.9 whereas a less popular RKP may have been assigned a score of 0.3 (these values are for illustration only). In certain embodiments, the boost in ratings due to popularity is only used to boost positive scores, i.e., for boosting matches arising from positive intent phrase fragments.

In certain embodiments of the present disclosure, the quality rating assigned to a match (i.e., the quality rating of the social lead that is generated based on this match) depends on the length (word count) of the matching TRKP. Merchants may be more interested in learning of matches against relatively long phrases, because longer phrases may be indicative of greater specificity on the part of the user's desire. An increased quality rating may be assigned if the matching TRKP is longer than a predetermined threshold number of words, for example. For example, if scores are assigned in the range [−1, 1], a 0.2 point “bonus” may be awarded for a matching RIP containing a matching TRKP that is longer than four words, with the score still capped at +1 after the bonus.

In certain embodiments of the present disclosure, the naked phrases (TRKPs) are first used to search for matches against the social feed input. If a match is found for a naked phrase, the entire message posted by the user and containing the matching component is retrieved from the social feed input. For example, suppose a user of an online social network had posted a message “I just got back from winter break . . . I am going to miss Mom's cooking, especially her deep dish pizzas!” and suppose the phrase “deep dish pizzas” matched the naked phrase “deep dish.” The entirety of the foregoing posted message may be compared against all of the IPFs available in the database. If a match is found for an IPF, the quality rating may be assigned as a first type (e.g., a positive score which may be influenced by popularity and/or word count, as described above). If, on the other hand, a match is found for a NIPF, the quality rating may be assigned as a second type (e.g., negative score). If no matches are found for IPFs and no matches are found for NIPFs, the quality rating may be assigned as a third type (e.g., zero score).

In certain embodiments of the present disclosure, the quality rating is used as a filter to only show the merchant relatively “hot” social leads. For example, a pizza merchant may not be interested in learning of matches deriving from a user's post “I will never eat pizza again!” In certain embodiments, only matches having a quality rating greater than or equal to a particular threshold (e.g., ≧0, in the [−1, 1] scoring example given above) may be considered as social leads that should be displayed to the merchant. Alternatively, all social leads (regardless of quality rating) may be displayed in certain implementations, e.g., in case a merchant of vodka suspects an opportunity when a user posts “I will never drink shots of tequila again!” In certain embodiments, only social leads meeting a location requirement are displayed to the merchant, e.g., if the merchant is in New York City and only wants to learn of potential customers within 10 miles of New York City. The social leads (whether or not pre-filtered based on a score cutoff) may be displayed (e.g., on a graphical user interface or dashboard) with a visual indication of how “hot” each lead is. For example, different colors may be used for hot vs. average leads (i.e., based on scores falling in respective score intervals), or visual indicators such as stars may be used for this purpose.

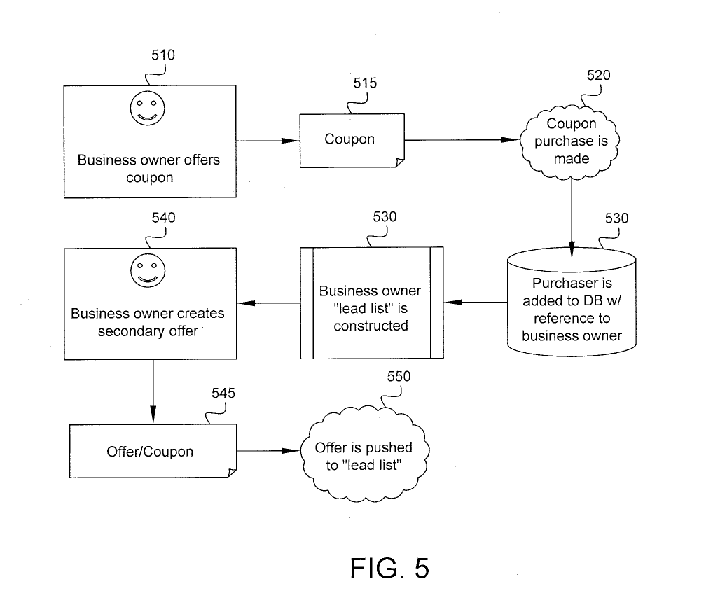

Some embodiments of the present disclosure provide merchants with leads based on usage of coupons. FIG. 5 is a flow diagram for secondary direct marketing based on group coupons in accordance with certain embodiments. At block 510, a merchant offers a coupon 515, e.g., an electronic coupon or a print coupon. A consumer redeems the coupon (520) using any suitable redemption method. System 140 detects redemption of the coupon and adds the consumer's identity to a database with reference to the merchant (530). In this manner, a list of leads (“lead list”) is constructed (530) for the merchant. The merchant is notified of new leads, e.g., upon logging into system 140 or through a separate channel such as an email or other message sent from system 140 to the merchant. At 540, the merchant may then create a secondary offer (e.g., a second coupon/offer 545), which is pushed (550) to one or more members of the merchant's lead list. In this context, “pushed” may be refer to delivery via email, message pop-up on a mobile device configured with a group coupon application, physical mail, a “press 1” campaign, or other message delivery technique. As one of ordinary skill will understand, a “press 1” campaign refers to a technique whereby a person is automatically telephoned, and a prerecorded message is played to the person, who has the option of pressing “1” (in one example) to be connected with a live person. Thus, in certain embodiments a merchant is provided with a list of leads that is augmented based on coupon usage, and the lead list can be directly marketed to in association with customer loyalty or customer retention programs.

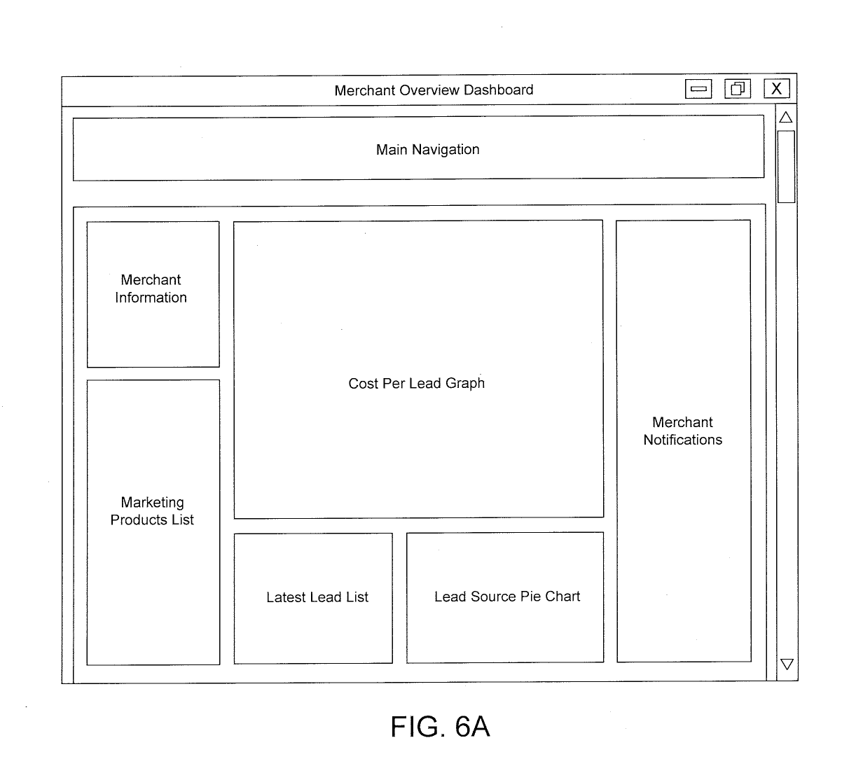

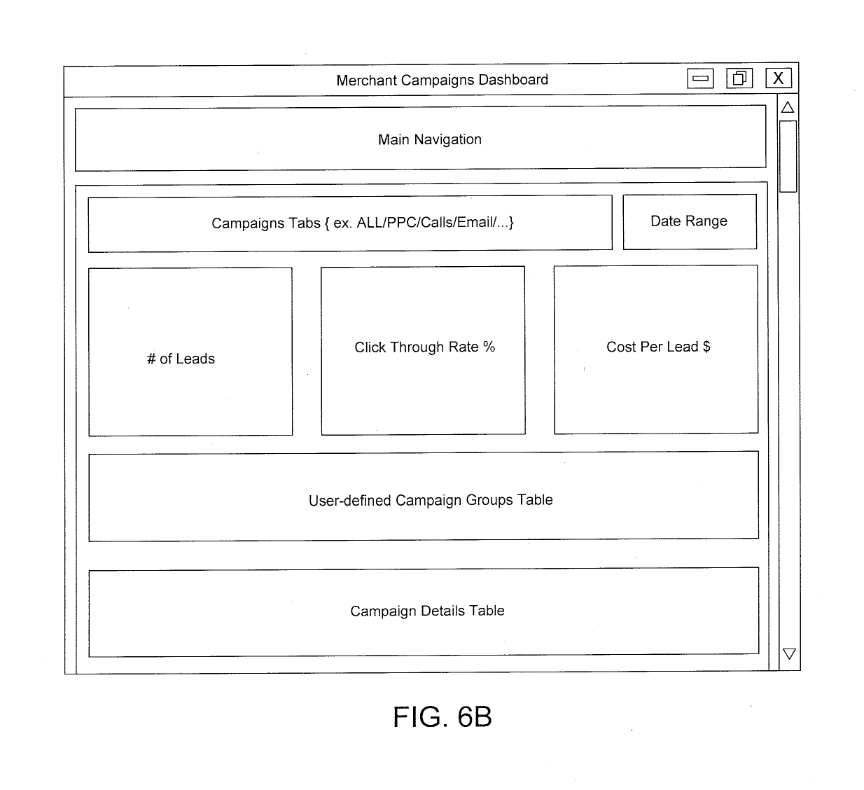

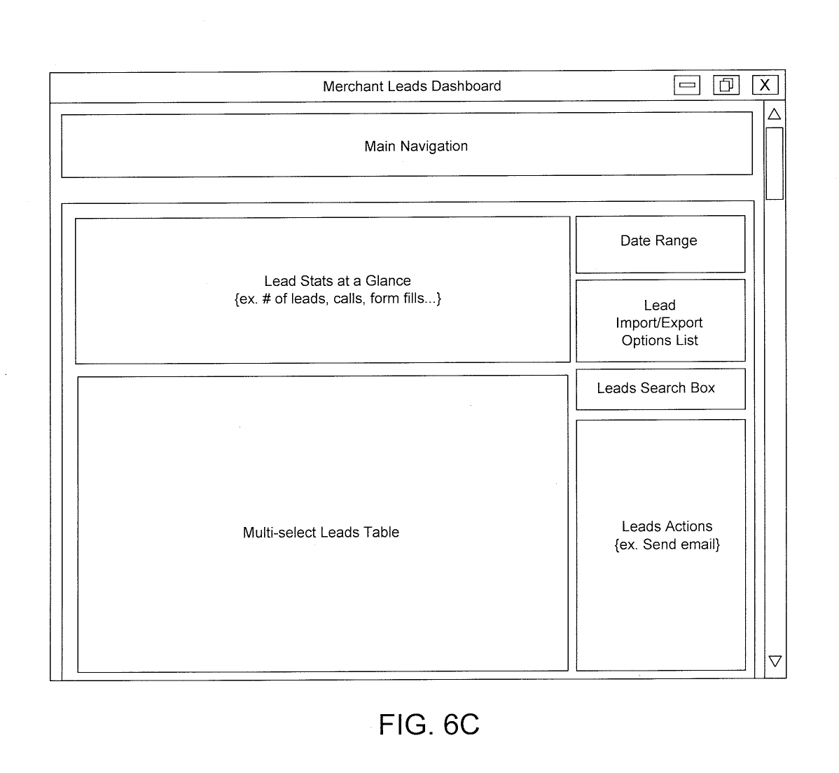

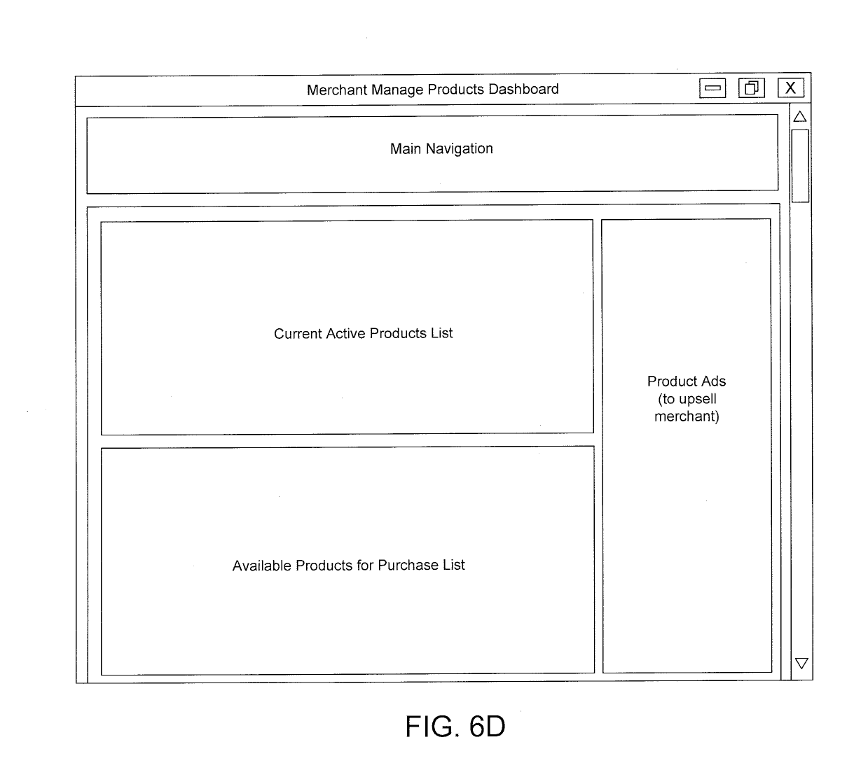

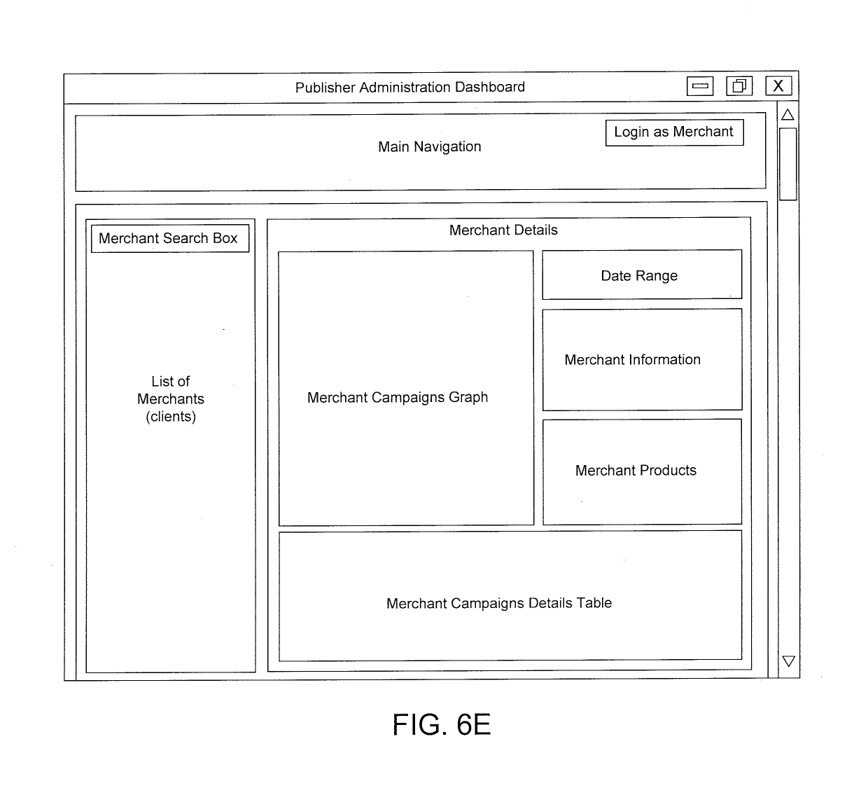

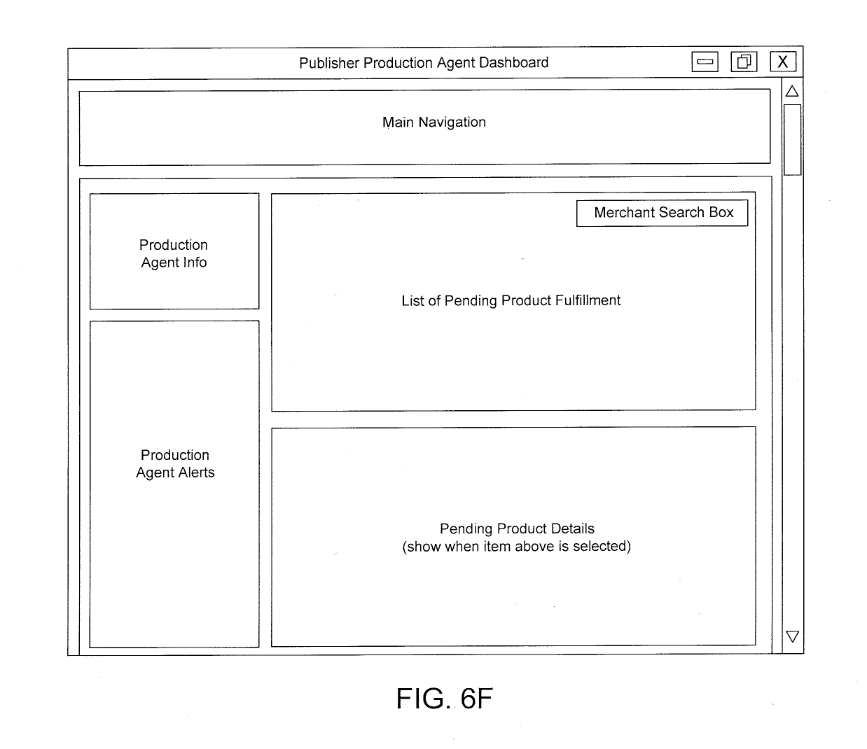

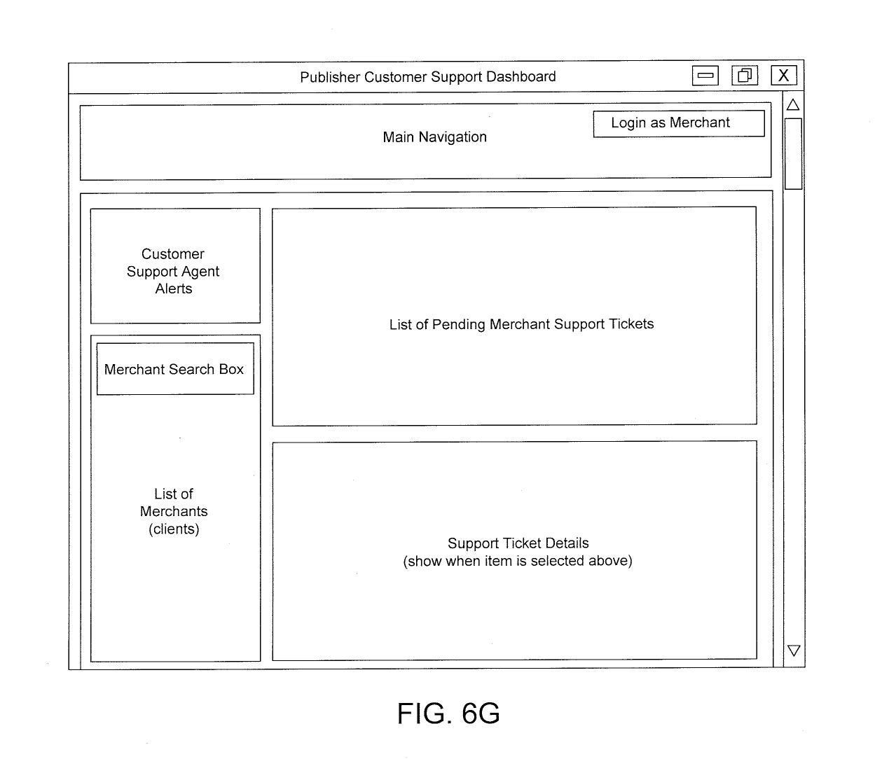

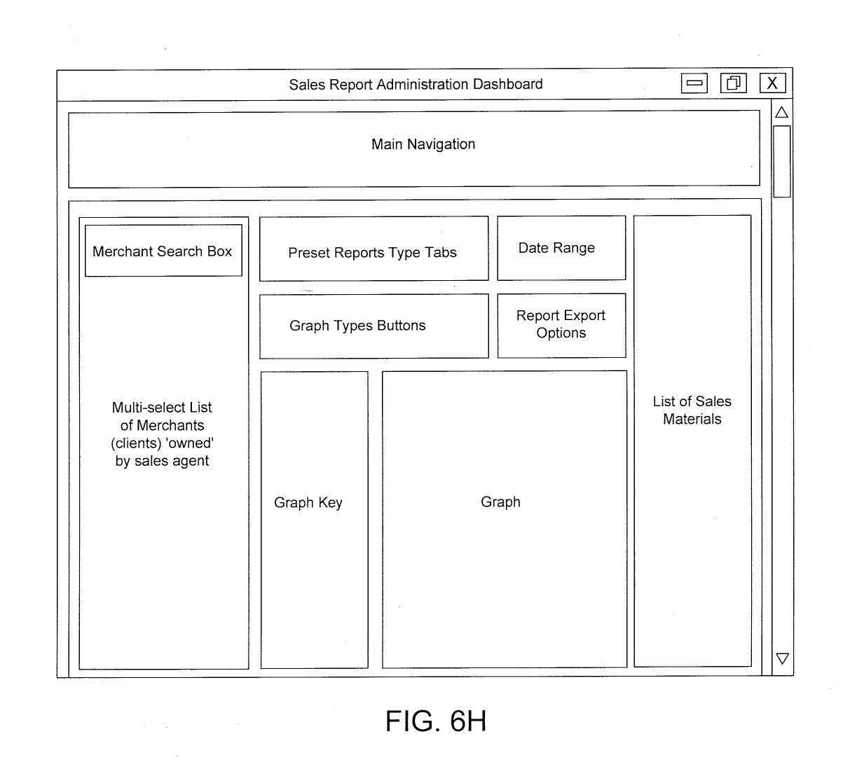

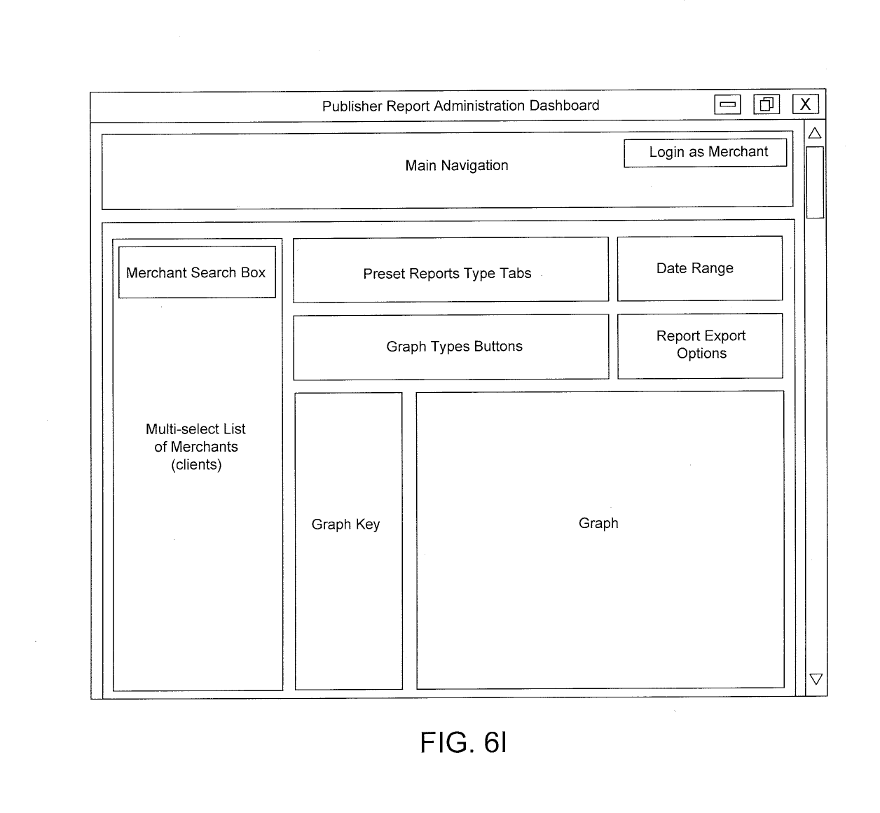

Referring back to FIG. 1, system 140 provides several dashboards for displaying various types of information relevant to advertising campaigns to merchants 110 and system administrators. A dashboard is a graphical user interface that can provide at-a-glance access to various types of information. Example dashboards provided by system 140 are depicted in FIGS. 6A-6I.

Various dashboards shown in FIGS. 6A-6D provide a snapshot view for tracking an advertising campaign of a merchant across various marketing channels. These dashboards are referred to as a Merchant Overview dashboard, Merchant Campaigns dashboard, Merchant Leads dashboard, and Merchant Manage Products dashboard in FIGS. 6A, 6B, 6C, and 6D, respectively. These dashboards display up-to-date information about business leads for the merchant. A lead includes information (e.g., name, phone number, or IP address of a computer that generated a hit for a merchant's advertisement) associated with a possible customer for the merchant. The dashboards shown in FIGS. 6A-6D may display metrics such as the cost, per lead, of the merchant's advertising campaign, and may rank the leads, e.g., to show how “hot” or relevant each lead is.

Referring to FIG. 6E, a Publisher Administration dashboard provided by system 140 includes an interface by which the accounts of various merchants 110 who use system 140 may be managed. Via this dashboard, an administrator of system 140 may view information about the various merchants using system 140, may manage authorized merchants and configure their accounts on system 140, may manage the various integrated marketing services for each merchant, and may optimize the analysis of data regarding customers or potential customers of each merchant in order to provide targeted recommendations. For example, the administrator may aggregate data into a convenient format such as graphs that allow identification of trends and anomalies. In certain embodiments, automatic detection of trends and anomalies facilitates the provision of recommendations to a merchant 120 for improving its advertising implementation. An administrator may also share notes and reports regarding an advertising account with a merchant 120 or with other administrators of system 140 (e.g., members of an account team responsible for the merchant's advertising campaign). Branding issues related to use by a particular merchant (and integration with the merchant's existing materials) may also be controlled through the Publisher Administration dashboard.

Referring to FIG. 6F, a Publisher Production Agent dashboard shows merchants 120 the status of products (e.g., services such as domain name registration, map listings, or social broadcast lead tracking as described below) related to the merchant's advertising campaign that a merchant requests from system 140. Using this dashboard, a merchant can request system 140 for additional services as needed, providing a flexible mechanism for tailoring the merchant's advertising campaign. Form-based production may be used, wherein a merchant fills in basic information on a form or template regarding the requested service(s).

Referring to FIG. 6G, a Publisher Customer Support dashboard may enable a merchant using system 140 to view its current account information. This dashboard may include all the features of the Publisher Administration dashboard but without the ability for a merchant to modify data, i.e., read-only functionality. The Publisher Customer Support dashboard may include a ticket system that enables merchants to request changes to their advertising campaigns.

Referring to FIG. 6H, a Sales Report Administration dashboard shows performance of current and past merchants who are using or have used system 140. Sales materials of various merchants may be viewed and tracked using this dashboard. Such sales materials may include documents (e.g., pay-per-click upselling documents) for upselling (a sales/marketing practice involving persuading a buyer to buy a related product) a merchant regarding an additional product.

Referring to FIG. 6I, a Publisher Report Administration dashboard provides presentation-quality reporting about merchants' advertising campaigns. This dashboard shows trends in clicks and impressions. An impression occurs when an advertising is downloaded by a user (or, more precisely, a user's computer) while viewing a page. The Publisher Report Administration dashboard can combine data across several advertising accounts shown on the advertising dashboard, and can also provide a narrow view directed at an individual merchant and advertising campaign. This dashboard can provide an administrator of system 140 with a proxy login that simulates the experience a merchant 120 would have when accessing system 140. In other words, the Publisher Report Administration dashboard enables a system administrator to view the system from the merchant's perspective. In certain embodiments, a merchant can view a dashboard that is optimized to the merchant's interests and/or needs, and an administrator can view a dashboard that contains aggregated data from various merchants and data regarding how many products were produced for respective merchants by the administrator's product teams. Such products may include products offered by system 140 to a merchant 110, e.g., products such as a website, pay-per-click campaign, coupons (e.g., online coupons), etc. The products are created by one or more product teams (also referred to as production teams). In certain instances, a production component (e.g., production team) of a publisher 160 provides information to a production team of associated with system 140 (e.g., administrators of system 140) for completion of production. System 140 provides merchants 110 with various services integrated into a single portal that is convenient for the merchants to access via the Internet. Merchants do not have to transact separately with various different service providers but can instead use a single sign-on (SSO) to portal 140 to accomplish various tasks.

For example, system 140 provides a merchant the capability to check available domain names and purchase an available domain name System 140 provides a form-based interface for creation of a website based on inputs from a merchant. For example, a merchant may supply information regarding its address, type of business, products offered, and keywords associated with such product offerings, and system 140 generates content (e.g., web pages that are optimized for a search engine) for a website for the merchant. The website builder tool provided by system 140 may include a what-you-see-is-what-you-get (WYSIWYG) editor for merchants to edit content on their websites.

Merchants may advertise their products on the websites of other entities using a pay-per-click (PPC) advertising model. For example, merchant 110a may use its website as a vehicle for displaying advertisements for merchant 110b (i.e., merchant 110b purchases advertisements using the PPC model). If a person clicks (or otherwise selects, using a suitable input modality) on an advertisement for merchant 110b shown on the website of merchant 110a, merchant 110b pays merchant 110a a predetermined amount. System 140 provides management of pay-per-click advertising, tracking click-throughs and relevant statistics (e.g., time of click, source of click) and providing relevant conversions based on various localities and currencies. Thus, various embodiments provide tools for managing the advertising expenditures of merchant 110b who purchased advertising space.

In addition to assisting merchants with the maintenance of their websites, system 140 provides merchants the capability to publish and manage data across various platforms. For example, a restaurant can use system 140 to publish its name, location, and other associated information (e.g., operating hours) across popular local search platforms (i.e., websites that enable individuals to locate products in a particular region) and/or mobile platforms (e.g., applications for mobile devices that provide similar local search functionality).

Consumers are increasingly using their cell phones and other mobile devices to scan barcodes using the built-in camera of such devices to obtain information about merchants. For example, merchants commonly embed two-dimensional barcodes in advertisements located in print media, on garments of clothing, on billboards, etc. A consumer who sees the barcode can scan it with her mobile device to obtain information about a product or the merchant. System 140 enables merchants 110 to market their products to consumers 120 using such barcodes. For example, system 140 creates barcodes that, when scanned, link an individual to a merchant's website, which may provide information about a product offered by the merchant.

System 140 may provide other services to merchants in certain embodiments of the present disclosure. For social broadcasting, system 140 enables a merchant to send a status update (e.g., news about the merchant or its products) to multiple social sites automatically. System 140 may provide links on a website (e.g., a merchant's website) that enable a person to form an association with the merchant on a social networking site (e.g., enable the person to become a “fan” of the merchant or “like” the merchant). System 140 may provide synchronization between a merchant's website as displayed on mobile devices (where formatting restrictions may apply) and the website as displayed on other types of devices. System 140 also provides a customer service ticketing system for a merchant to keep track of service requests from the merchant's customers. Additionally, system 140 provides email marketing and tracking capabilities to support a merchant's advertising campaign.

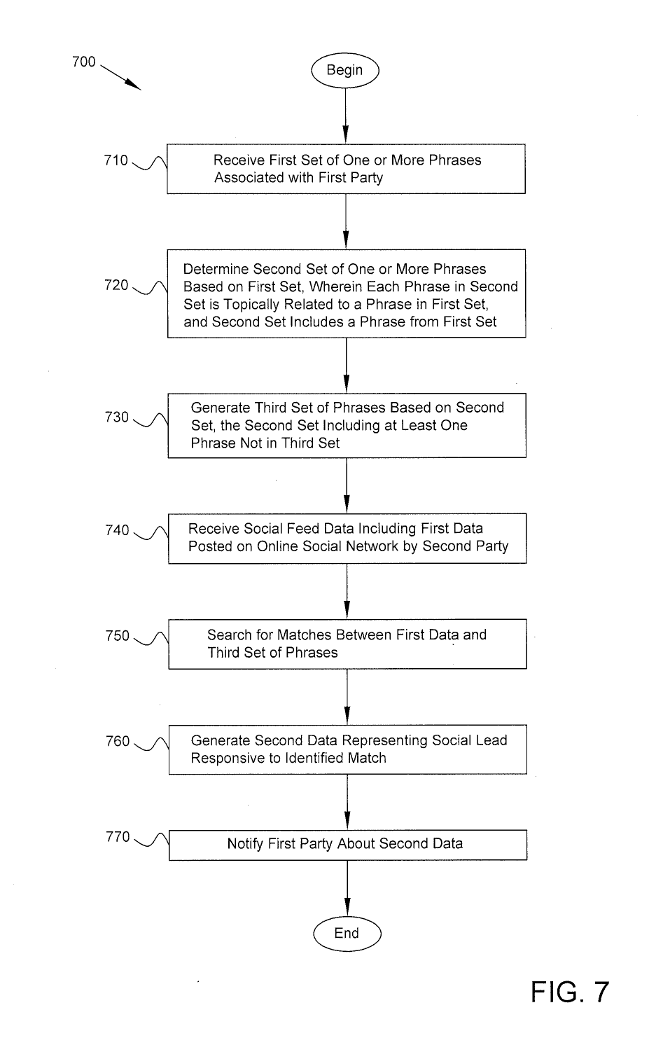

FIG. 7 is a flow diagram of a process in accordance with certain embodiments of the present disclosure. After process 700 begins, a first set of one or more phrases associated with a first party is received (block 710) from the first party. Using at least one computer processor, a second set of one or more phrases is determined (block 720) based on the first set, wherein each phrase in the second set is topically related to at least one phrase in the first set, and the second set includes at least one phrase from the first set of phrases. Using at least one computer processor, a third set of phrases is generated (block 730) based on the second set of phrases, the second set including at least one phrase that is not in the third set. Social feed data, including first data posted on at least one online social network by a second party, is received (block 740). At least one computer processor is used for automatically searching (block 750) for matches between the first data and a third set of phrases, wherein the third set is based on the second set of phrases. Responsive to an identified match identified by said searching, second data representing a social lead is generated (block 760). The second data includes contact information of the second party. The first party is notified (block 770) about the second data.

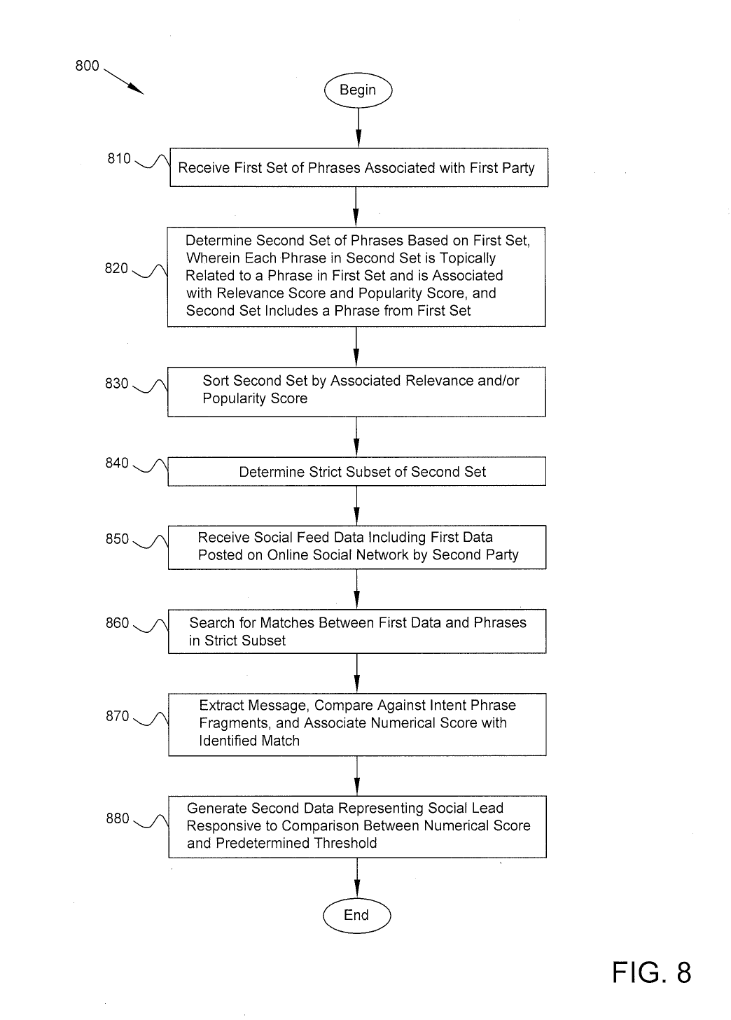

FIG. 8 is a flow diagram of a process in accordance with certain embodiments of the present disclosure. After process 800 begins, a first set of one or more phrases associated with a first party is received (block 810) from the first party. Using at least one computer processor, a second set of one or more phrases is determined (block 820) based on the first set. Each phrase in the second set is topically related to at least one phrase in the first set and is associated with a relevance score and a popularity score. The second set includes at least one phrase from the first set of phrases. At block 830, the second set of phrases is sorted by at least one of the associated relevance scores and the associated popularity scores. Based on said sorting, a strict subset of the second set of phrases is determined (block 840). Social feed data, including first data posted on at least one online social network by a second party, is received (block 850). At least one computer processor is used for automatically searching (block 860) for matches between the first data and the phrases in the strict subset of the second set of phrases. At block 870, responsive to an identified match identified by said searching, a message is extracted which includes the first data from the social feed data, the message is compared against a set of one or more intent phrase fragments, and a numerical score is associated with the identified match. The numerical score depends on whether the message includes at least one of the intent phrase fragments. Responsive to a comparison between the numerical score and a predetermined threshold, second data representing a social lead is generated (block 880). The second data includes contact information of the second party.

Although examples are illustrated and described herein, embodiments are nevertheless not limited to the details shown, since various modifications and structural changes may be made therein by those of ordinary skill within the scope and range of equivalents of the claims.

1. A computer-implemented advertising management method performed over a network, the method comprising:
receiving, from a first party, a first set of one or more phrases associated with the first party;
using at least one computer processor, determining a second set of one or more phrases based on the first set, wherein each phrase in the second set is topically related to at least one phrase in the first set, and the second set includes at least one phrase from the first set of phrases;
using at least one computer processor, generating a third set of phrases based on the second set of phrases, the second set including at least one phrase that is not in the third set;
receiving a social feed data including first data posted on at least one online social network by a second party;
using at least one computer processor, searching for matches between the first data and the third set of phrases;
generating second data representing a social lead, the second data including contact information of the second party, wherein the second data is generated responsive to an identified match identified by said searching; and
notifying the first party about the second data.

2. The computer-implemented advertising management method of claim 1, wherein each phrase in the second set is associated with a relevance score and a popularity score, and wherein generating the third set of phrases includes:
sorting the second set of phrases by at least one of the associated relevance scores and the associated popularity scores;
determining, based on said sorting, a strict subset of the second set of phrases; and
concatenating an intent phrase fragment with one of the phrases in the strict subset of the second set.

3. The computer-implemented advertising management method of claim 2, wherein generating the third set of phrases further includes concatenating a negative intent phrase fragment with one of the phrases in the strict subset of the second set.

4. The computer-implemented advertising management method of claim 2, further comprising generating a quality rating for the identified match, wherein the quality rating is dependent on a popularity score associated with one of the phrases, corresponding to the identified match, in the strict subset of the second set.

5. The computer-implemented advertising management method of claim 2, further comprising generating a quality rating for the identified match, wherein the quality rating is dependent on the number of words in one of the phrases, corresponding to the identified match, in the strict subset of the second set.

6. The computer-implemented advertising management method of claim 5, wherein the quality rating is increased by a fixed or variable amount responsive to a determination that said number of words exceeds a predetermined threshold.

7. The computer-implemented advertising management method of claim 1, wherein the social feed data does not include data posted on said at least one online social network by any party other than the second party.

8. The computer-implemented advertising management method of claim 1, wherein the social feed data further includes third data posted on said at least one online social network by a third party.

9. The computer-implemented advertising management method of claim 1, further comprising generating a quality rating for the identified match.

10. The computer-implemented advertising management method of claim 9, wherein the quality rating is a numerical score, and the second data is generated responsive to a comparison between the numerical score and a predetermined threshold.

11. The computer-implemented advertising management method of claim 1, further comprising:
adding the generated second data to a list of social leads associated with the first party; and
displaying the list of social leads to the first party.

12. The computer-implemented advertising and marketing management method of claim 1, wherein the social feed data further includes the contact information of the second party.

13. The computer-implemented advertising management method of claim 1, further comprising sending a promotional electronic message to the second party regarding a topic associated with the identified match.

14. The computer-implemented advertising management management method of claim 13, wherein the promotional message is sent automatically based on a previously configured rule.

15. The computer-implemented advertising management method of claim 13, further comprising receiving an instruction from the first party regarding the social lead, wherein the promotional message is sent responsive to the received instruction.

16. A non-transitory computer-readable storage medium comprising computer-executable instructions stored thereon, said instructions when executed causing at least one computer processor to perform the operations of:
receiving, from a first party, a first set of one or more phrases associated with the first party;
determining a second set of one or more phrases based on the first set, wherein each phrase in the second set is topically related to at least one phrase in the first set, and the second set includes at least one phrase from the first set of phrases;
generating a third set of phrases based on the second set of phrases, the second set including at least one phrase that is not in the third set;
receiving social feed data including first data posted on at least one online social network by a second party;
searching for matches between the first data and the third set of phrases;
generating second data representing a social lead, the second data including contact information of the second party, responsive to an identified match identified by said searching; and
notifying the first party about the second data.

17. The non-transitory computer-readable storage medium of claim 16, wherein each phrase in the second set is associated with a relevance score and a popularity score, the instructions when executed further causing the at least one processor to perform the operations of:
sorting the second set of phrases by at least one of a relevance score and a popularity score; and
determining, based on said sorting, a strict subset of the second set of phrases;
wherein the third set of phrases includes at least one concatenation of an intent phrase fragment with one of the phrases in the strict subset of the second set.

18. The non-transitory computer-readable storage medium of claim 16, the instructions when executed further causing the at least one processor to perform the operation of generating a quality rating for the identified match.

19. The non-transitory computer-readable storage medium of claim 16, the instructions when executed further causing the at least one processor to perform the operation of sending a promotional electronic message to the second party regarding a topic associated with the identified match.

20. A computer-implemented advertising management method comprising:
receiving, from a first party, a first set of one or more phrases associated with the first party;
using at least one computer processor, determining a second set of one or more phrases based on the first set, wherein each phrase in the second set is topically related to at least one phrase in the first set and is associated with a relevance score and a popularity score, and the second set includes at least one phrase from the first set of phrases;
sorting the second set of phrases by at least one of the associated relevance scores and the associated popularity scores;
determining, based on said sorting, a strict subset of the second set of phrases;
receiving social feed data including first data posted on at least one online social network by a second party;
using at least one computer processor, automatically searching for matches between the first data and the phrases in the strict subset of the second set of phrases; and
responsive to an identified match identified by said searching, extracting a message including the first data from the social feed data, comparing the message against a set of one or more intent phrase fragments, and associating a numerical score with the identified match, wherein the numerical score depends on whether the message includes at least one of the intent phrase fragments; and
generating second data representing a social lead, the second data including contact information of the second party, responsive to a comparison between the numerical score and a predetermined threshold.

21. The computer-implemented advertising management method of claim 20, wherein the numerical score associated with the identified match is set to a positive numerical score responsive to a determination that the message includes at least one of the intent phrase fragments.

22. The computer-implemented advertising management method of claim 21, wherein the magnitude of the positive numerical score is based on the popularity score associated with the phrase, corresponding to the identified match, in the strict subset of the second set.

23. The computer-implemented advertising management method of claim 20, further comprising:
responsive to a determination that the message does not include any of the intent phrase fragments, comparing the message against a set of one or more negative intent phrase fragments, wherein the numerical score depends on whether the message includes at least one of the negative intent phrase fragments.

24. The computer-implemented advertising management method of claim 23, wherein the numerical score associated with the identified match is set to a negative numerical score responsive to a determination that the message includes at least one of the negative intent phrase fragments.

25. The computer-implemented advertising management method of claim 23, wherein the numerical score associated with the identified match is set to a zero score responsive to a determination that the message does not include any of the negative intent phrase fragments.

26. The computer-implemented advertising management method of claim 23, wherein the predetermined threshold is a zero score.

27. The computer-implemented advertising management method of claim 20, further comprising notifying the first party about the second data.
